(19) United States
(12) Patent Application Publication
(10) Pub. No.: US 2016/0348690 A1
(43) Pub. Date: Dec. 1, 2016

(54) OPERATION OF A GAS TURBINE SYSTEM IN PART LOAD OPERATION

(71) Applicant: SIEMENS AKTIENGESELLSCHAFT, München (DE)

(72) Inventors: Marco Larson, Mülheim (DE); Nicolas Savilius, Essen (DE)

(73) Assignee: Siemens Aktiengesellschaft, Munich (DE)

(21) Appl. No.: 15/116,621

(22) PCT Filed: Feb. 5, 2015
(86) PCT No.: PCT/EP2015/052412

§ 371 Date: Aug. 4, 2016

(30) Foreign Application Priority Data
Feb. 12, 2014 (EP) 14154803.2

(51) Int. Cl. F04D 29/36; F02C 7/047; F04D 27/00; F02C 7/08; F02C 3/34; F02C 7/143; F02C 7/057; F02C 7/042

(52) U.S. Cl. CPC F04D 29/368; F02C 7/057; F02C 7/047; F02C 7/042; F02C 7/08; F02C 3/34; F02C 7/1435; F04D 27/001; F05D 2270/311; F05D 2270/313; F05D 2220/32; F05D 2270/07; F05D 2270/08

(57) ABSTRACT

A method for operating a gas turbine system in part load operation wherein a compressor pre-guide blade adjustment for part load operation is initiated in case of a given state of a flow medium which flows into a compressor, a value of the initiated compressor pre-guide blade adjustment is compared with a compressor pre-guide blade adjustment limit value which is determined depending on the state of the flow medium, and, if the value of the initiated compressor pre-guide blade adjustment meets a predefined condition with regard to the compressor pre-guide blade adjustment limit value, at least one measure is initiated for changing the state of the flow medium which flows into the compressor in part load operation. An arrangement has an actuating device, determining device and control unit to carry out the method. The gas turbine system has an anti-icing device and/or an intake air heating device and the arrangement.

### CROSS REFERENCE TO RELATED APPLICATIONS

This application is the US National Stage of International Application No. PCT/EP2015/052412 filed Feb. 5, 2015, and claims the benefit thereof. The International Application claims the benefit of European Application No. EP14154803 filed Feb. 12, 2014. All of the applications are incorporated by reference herein in their entirety.

### FIELD OF INVENTION

The invention relates to a method of operating a gas turbine system in part load operation and to an arrangement for controlling a gas turbine system in part load operation as well as to a gas turbine system having a compressor pre-guide blade adjusting device.

### BACKGROUND OF INVENTION

Among other things, gas turbine systems or gas turbines are used to generate energy in gas-fired power stations. The constructive and/or process-related design and optimization of gas turbines are usually aimed at nominal and/or full load operation which is as cost-effective and low in exhaust emissions as possible.

Operating a gas turbine system in part load operation—namely with an output below the nominal load, i.e. predominantly outside a primary design range of the gas turbine system—is therefore particularly problematical with regard to the achievable efficiency levels and exhaust emissions values.

Gas turbine systems, hereinafter referred to in brief as gas turbines, are internal combustion engines which draw in ambient air, compress this in a compressor, produce an ignitable flow medium from this compressed ambient air and a fuel in a combustion chamber or burner unit, ignite and decompress this in a turbine or turbine unit, wherein thus released thermal energy is converted into rotary mechanical energy. The mechanical power generated thereby in the turbine, in addition to the portion which can be used for conversion into electrical power through a generator arranged downstream in the gas turbine system, is partially also taken to the compressor for performing compression work.

On the basis of operation of the gas turbine at nominal load or above an intended part load, in order to reduce the gas turbine output, i.e. to operate the gas turbine in part load operation, a fuel mass flow into the burner unit is usually reduced and/or a compressor intake air mass flow decreased.

The reduction in the compression intake air mass flow is usually achieved with a variable compressor pre-guide blade, i.e. by a compressor pre-guide blade adjusting device of the gas turbine, wherein in this connection this is also referred to as throttling. Through the throttling a fuel-air ratio for the compression is to be attained which permits as fuel-efficient and exhaust emission-free part load operation of the gas turbine as possible.

The maximum permitted throttling, i.e. the maximum permitted adjusting of the variable compressor pre-guide blade and thus the adjusting range in partial load operation is limited by the vacuum-related expansion of the ambient air in the intake area of the compressor:

Depending on the temperature and humidity of the intake air, in the event of exceeding or falling below a compressor pre-guide blade adjustment limit value, icing or ice formation can occur in the compressor of the gas turbine system. Consequently this can result in impairment of the so-called machine integrity and possibly damage to the machine.

From the prior art various methods of operating a gas turbine system in part load operation are known, in particular for preventing icing in the compressor of the gas turbine.

Such a method for a gas turbine system is known from EP 2 180 165, wherein a heat exchanger and a unit for air conditioning serve to sufficiently supply the air drawn in by the gas turbine system with heat energy. The supply of heat by means of the heat exchanger is started approximately at a time when the drawn-in air is at a temperature which is below a limit value, around 40° C., and the temperature is less than 10° C. from the current dew point temperature. To support this procedure it can also be envisaged that the compressor pre-guide blades are suitably operated.

Temperature conditioning to influence the temperature of the intake air of a gas turbine is also described in EP 2642092A1, Here the gas turbine is integrated into a combined gas and steam power station and the temperature conditioning is carried out in such a way that the steam temperature in the steam section of the combined gas and steam power station is brought to or above a nominal temperature. At the same time the compressor pre-guide blades of the gas turbine can additionally support this regulating process in that their position is also made dependent on this steam temperature.

However in the case of none the documents familiar from the prior art is it known to advantageously determine a compressor pre-guide blade adjustment limit value in order to achieve fuel-efficient controlling of the compressor pre-guide blade adjustment. More particularly, the methods and/or devices from the prior art cannot make any statements in relation to the definition of a compressor pre-guide blade adjustment limit value in the meaning according to the invention.

### SUMMARY OF INVENTION

An aim of the invention is therefore to propose an advantageous technical teaching regarding the operation of a gas turbine system in part load operation. In particular, the invention is based on the task of achieving a fuel-efficient and low exhaust emission part load operation of a gas turbine system through extending the compressor pre-guide blade adjustment range which is determined by means of at least one compressor pre-guide blade adjustment limit value.

According to aspects of the invention this task is solved with a method of operating a gas turbine system in part load operation, an arrangement for controlling a gas turbine system in part load operation and a gas turbine system having a compressor pre-guide blade adjusting device with the features of the relevant independent claim. Expedient embodiments and advantages of the invention are set out in the further claims and the description and relate to the method, the arrangement and the gas turbine system.

In the method, with a given state of a medium flowing into a compressor of the gas turbine system, a compressor pre-guide blade adjustment for part load operation is initiated.

The given state of the inflowing medium can be determined through at least one parameter such as a temperature, a moisture content or humidity, a pressure, i.e. in particular through numerical values of these parameters. In connection with this “given” also means “present”, “prevailing” and/or “measurable” or “determinable”. The flow medium flowing into the compressor of the gas turbine system can, in particular, be ambient air or intake air. The compressor pre-guide blade adjustment can be an adjustment of a variable, i.e. adjustable, compressor pre-guide blade (compressor pre-guide blade series). The adjustment is not necessarily restricted to the compressor pre-guide blade or compressor pre-guide blade series, but can also include further guide blade series, in particular 1 to 5 further guide blade series. In this context and below “initiated” or “initiation” can relate on the one hand to the triggering of the adjustment or a measure as such, for example through operating and/or actuating a corresponding device, and on the other hand to an effect of the adjustment or measure in a method or process-related sense.

Through the compressor pre-guide blade adjustment a reduction in the intake air mass flow into the compressor of the gas turbine system can be achieved in a simple manner. Consequently, in part load operation of the gas turbine system, with a reduced fuel mass flow an almost constant air-fuel ratio can be achieved, which advantageously results in lower emissions values and consistently high exhaust gas temperatures. The resulting high exhaust gas temperature is particularly advantageous for use in a downstream steam process in a combined gas turbine and steam power station.

A value of the initiated compressor pre-guide blade adjustment is compared with a compressor pre-guide blade adjustment limit value which can be determined depending on the state of the medium flowing into the compressor of the gas turbine system.

“Can be determined” in this connection and below is taken to mean an appropriate possibility of determining, establishing, a measurement—in each case indirectly or directly—or of calculating a value. The term “compared” or “compare” relates to a numerical balancing of two values, more particularly through producing a difference by way of a technical device.

The compressor pre-guide blade adjustment limit value is a limit value to be observed for procedural and/or safety reasons in the adjustment of the compressor pre-guide blade or guide blade (guide blade series), which if not observed can result in the occurrence of ice formation or icing of the compressor—and consequently impairment of a gas turbine function or failure of the gas turbine.

Determination of the compressor pre-guide blade adjustment limit value depending on the state of the medium flowing into the compressor of the gas turbine system, for example depending on the actual intake air temperature and/or the actual intake air humidity, is of particular advantage: compared with the usual worst-case scenario (compressor pre-guide blade adjustment limit value determined/established on the basis of an assumed minimum intake air temperature and an assumed maximum intake air humidity) an extended compressor pre-guide blade adjustment range can be achieved. As a consequence of this a part load operation of the gas turbine which is more fuel efficient and lower in pollutant emissions can be made possible, particularly with high intake air temperatures and low intake air humidities.

If the value of the initiated compressor pre-guide blade adjustment fulfils a predefined condition with regard to the compressor pre-guide blade adjustment limit value, at least one measure is initiated for changing the state of the medium flowing into the compressor of the gas turbine system in part load operation.

The condition can be the exceeding or attaining of an upper limit value or the falling below or reaching a lower limit value for the adjustment of the compressor pre-guide blade. For example, one condition is exceeding a limit angle of the compressor pre-guide blade adjustment—which can be determined, for example, as function of the intake air humidity and intake air temperature and above which compressor icing can occur.

Through the change in the state—of a temperature and/or a humidity, for example—of the medium flowing into the compressor of the gas turbine system in part load operation—in particular the intake air—an influencing of the compressor pre-guide blade adjustment limit value is achieved in an advantageous manner. Thus the permissible compressor pre-guide blade adjustment range can be particularly advantageously expanded—especially in the case of low ambient air temperatures and ambient air humidities. Particularly advantageously a part load operation of a gas turbine system is thus attained which, well outside the original design range of the gas turbine system, also allows fuel-efficient and low-pollutant-emission operation with particularly low gas turbine outputs at particularly low ambient air temperatures and/or ambient air humidities.

The invention also envisages an arrangement for controlling a gas turbine system in a part load range. The arrangement has an actuating device, a determining device and a control unit.

The actuating device is set up in such a way that in a given state of a medium flowing into a compressor of the gas turbine system a compressor pre-guide blade adjustment can be initiated.

For example, by means of the actuating device a variable compressor guide blade series of the gas turbine system can be adjusted, in particular adjusted in terms of an angle of attack with regard to a main flow direction of the intake air of the compressor.

The determining device is set up in such a way that a compressor pre-guide blade adjustment limit value can be determined depending on the state of the medium flowing into the compressor of the gas turbine system and a value of the initiable compressor pre-guide blade adjustment can be compared with the compressor pre-guide blade adjustment limit value.

The determinability can relate to a possibility of evaluating, calculating—in each case in particular on the basis of a once-only measured or calculated and/or simulated characteristics range or a multi-dimensional functional relationship—in combination with a measurement and/or calculation, for example of an intake air temperature and/or humidity. For example, determinability can be implemented in the determining device in a hardware, software and/or hardware and software-based manner.

The control unit is set up in such a way that at least one measure can be initiated for changing the state of the medium flowing into the compressor of the gas turbine system in part load operation if the value of the initiated compressor pre-guide blade adjustment fulfils a predefined condition in relation to the compressor pre-guide blade adjustment limit value.

For example, the control unit can be configured in such a way that auxiliary units and/or devices of the gas turbine system, in particular heating and/or cooling and/or drying and/or humidifying devices, each for acting on the state of the intake air, can be actuated—i.e. can at least be switched on and off. More particularly, the control unit can be prepared for actuating an anti-icing device and/or an intake air heating device and/or an evaporative cooler.

The invention also envisages a gas turbine system having a compressor pre-guide blade adjusting device. A gas turbine system which can be particularly advantageously operated in part load operation can be achieved if it has an anti-icing device and/or an intake air heating device and the arrangement according to the invention.

Further developments of the invention are also set out in the dependent claims. The further developments relate to the method according to the invention, the arrangement according to the invention as well as the gas turbine system according to the invention.

The invention and the described further developments can be realized both in software and in hardware, utilizing a special electrical circuit for example.

It is also possible to realize the invention or a described further development through a computer-readable storage medium on which a computer program is stored which implements the invention or the further development.

The invention and/or every described further development can also be realized by a computer program product which has a storage medium on which a computer program is stored that implements the invention and/or the further development.

In an advantageous embodiment of the invention, the given state of the medium flowing into the compressor of the gas turbine system is at least described by a temperature and/or humidity of the medium.

Both the temperature and also the humidity/moisture content of the medium, i.e. the intake air, are parameters which can be measured with simple or cost-effective, widely tried and tested and inexpensive means, through which the state of the medium flowing into the compressor of the gas turbine system can be particularly advantageously described.

Advantageously the compressor pre-guide blade adjustment limit value can be determined depending on a temperature and/or a humidity of the medium flowing into the compressor of the gas turbine system.

The compressor pre-guide blade adjustment limit value can be a limit value to prevent ice formation in the compressor of the gas turbine system. The humidity (moisture content) can be a relative or an absolute value.

Thus, compared with the usual one-off determination of the compressor pre-guide blade adjustment limit value on the basis of an assumed minimum intake air temperature and an assumed maximum intake air humidity (worst case), an extended compressor pre-guide blade adjustment range can be achieved in a particularly advantageous manner. As a result of this, part load operation of the gas turbine which is more efficient and lower in pollutant emissions can be achieved, especially in the case of a high intake air temperature and low intake air humidity.

According to a further development of the invention the at least one measure brings about an increase in a temperature and/or a reduction in a humidity of the medium flowing into the compressor of the gas turbine system in part load operation.

The increase in the temperature of the medium (intake air) flowing into the compressor of the gas turbine system in part load operation can be brought about via an activation of a heating device and/or via a deactivation of a cooling device. This does not rule out the increase in temperature causing a change in the humidity.

The reduction in humidity or moisture content of the medium (intake air) flowing into the compressor of the gas turbine system in part load operation can be brought about via an activation of a drying device and/or via a deactivation of a humidifying device. This does not rule out the reduction in humidity or moisture content causing a change in the temperature.

One advantage of increasing the intake air temperature and reducing the intake air humidity, in particular the relative humidity of the intake air, is that with a constant compressor pre-guide blade adjustment, the risk of icing in the compressor decreases. Expressed simply, this means that with the same risk of icing, stronger throttling (compressor pre-guide blade adjustment) can be carried out and thereby more advantageous part load operation of the gas turbine system can be achieved.

In an advantageous embodiment of the invention the at least one measure is initiated through an activation of an anti-icing device and/or of an intake air heating device and/or of a turbine exhaust gas return device and/or of an intake air drying device and/or a deactivation of an evaporative cooler and/or of a compression inlet air chiller and/or of a water injection device.

The anti-icing device can be a device or an auxiliary unit of the gas turbine, which is prepared for feeding a flow medium compressed and thus heated by the compressor, for example air heated to 300° C. to 400° C., into the one intake air mass flow.

The intake air heating device can be a device or an auxiliary unit of the gas turbine which is prepared for heating an intake air mass flow by several K, in particular 1 K to 10 K.

The turbine exhaust gas return device can be a device or an auxiliary unit of the gas turbine which is prepared for feeding a strongly heated turbine exhaust gas, for example air heated to 500° C. to 600° C., into the one intake air mass flow.

Thus named evap coolers (evaporative coolers), compression inlet air chillers and water injection devices (fogging, overspray, wet compression) are devices known from the prior art for cooling and/or humidifying intake air which are usually used for increasing a maximum achievable gas turbine performance. If these are activated during part load operation, through their de-activation a particularly cost-effective relative intake air temperature increase and/or drying can be achieved.

In a simple manner, through the activation and/or deactivation, in addition to the already described advantageous extended throttling, the intake air mass flow can also be easily and directly reduced, through which the gas turbine performance in part load operation can advantageously be reduced further. Expressed in simple terms, particularly advantageous part load operation can be achieved by a combination of extended throttling and a directly density-related reduction in the intake air mass flow.

In a further embodiment variant it is proposed that the value of the initiated compressor pre-guide blade adjustment is an incremental value or an absolute value.

Expediently the value of the initiated compressor pre-guide blade adjustment is an angle.

Advantageously the compressor pre-guide blade adjustment limit value is an upper limit value and the predefined condition is attaining or exceeding the upper limit value or it is a lower limit value and the predefined condition is attaining or falling below the lower limit value.

Expediently the method is carried out in each case for a plurality of successive points in time, i.e. over a period of time. Typically the method is thus implemented for a period of time in such a way that at a certain time t1 a compressor pre-guide blade adjustment is initiated. Expediently the value of the compressor pre-guide blade adjustment—i.e. the value attained during the period of time after initiation—is, continuously or in certain time increments, compared with the compressor pre-guide blade adjustment limit value. In particular, the compressor pre-guide blade adjustment limit value is determinable at several successive points in time. Advantageously the predefined condition is checked at sufficiently small time intervals, for example at intervals of 0.1 s to 10 s. A high degree of immunity the part load operation of the gas turbine system to icing in the compressor can thus be simply achieved.

It is also proposed that the method is used to control a temperature and/or a humidity of the medium flowing into the compressor of the gas turbine system in part load operation. In this way the parameters decisive for permissible throttling can be controlled, through which simple controllability, in particular secured against compressor icing, of the part load operation of the gas turbine can be attained.

In an advantageous embodiment variant the method is used to control operation of a gas turbine system in part load operation, wherein one control variable is the temperature and/or one control variable is the humidity, one actuating variable is the value of the initiated compressor pre-guide blade adjustment and one control signal actuates an anti-icing device and/or one control signal actuates an intake air heating device and/or one control signal actuates an evaporative cooler.

Advantageously the control unit of the arrangement according to the invention is prepared for actuating an anti-icing device and/or an intake air heating device and/or an evaporative cooler.

The description of advantageous embodiments of the invention that has been set out so far contains numerous features which in the individual sub-claims are partially set out with several features combined. However, these features can expediently also be considered individually and combined into further rational combinations. More particularly, in accordance with the independent claims each of these features, individually and in any suitable combination, can be combined with the method according to the invention, the arrangement according to the invention and the gas turbine system according to the invention.

The above-described properties, features and advantages of this invention as well as the manner in which they are achieved become more clearly understandable in conjunction with the following description of the exemplary embodiments which are explained in more detail in connection with the drawings. The exemplary embodiments serve to explain the invention and do not restrict the invention to combination of features set out therein, including in relation to the functional features. Additionally, suitable features of each exemplary embodiment can also be considered in an explicitly isolated manner, removed from one exemplary embodiment, introduced into another exemplary embodiment to supplement it and/or combined with any of the claims.

### BRIEF DESCRIPTION OF THE DRAWINGS

FIG. 1 shows a section through a gas turbine system according to the invention with an arrangement for controlling the gas turbine system in part load operation,

FIG. 2 shows a schematic view of a control circuit for controlling the operation of the gas turbine system in part load operation,

FIG. 3 shows a diagram with state ranges and limit curves of the gas turbine system depending on the intake air humidity and the intake air temperature, and

FIG. 4 shows a diagram with performance curves of the gas turbine system depending on the compressor pre-guide blade adjustment and an exhaust gas temperature.

### DETAILED DESCRIPTION OF INVENTION

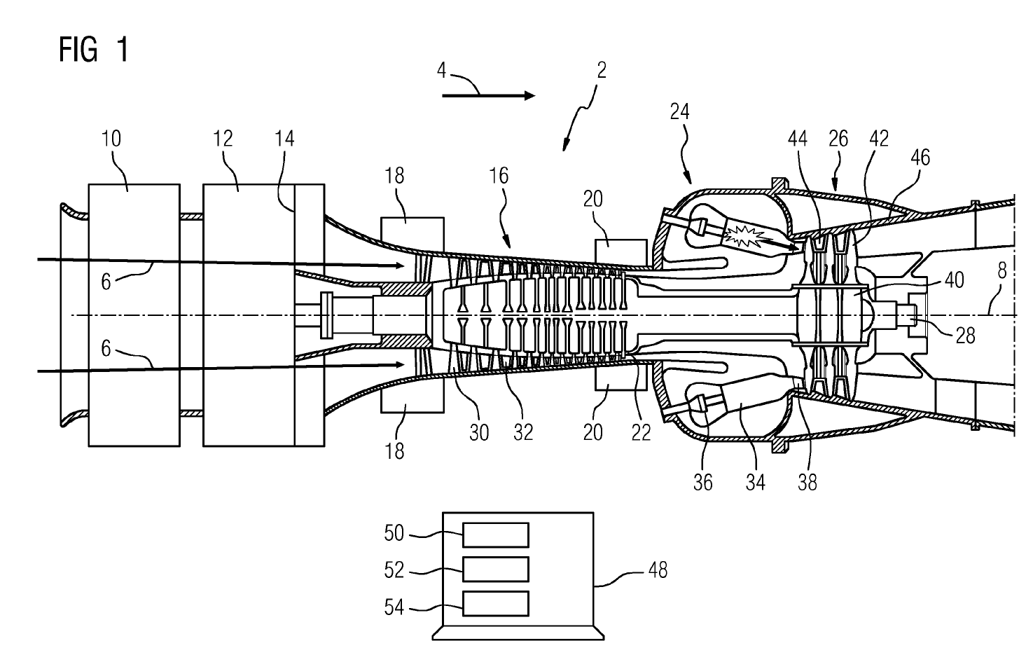

FIG. 1 shows a schematic view of a gas turbine system 2. In the following text the terms gas turbine system and gas turbine are used as equivalents. Among other things, in the main flow direction 4 the gas turbine 2 has a flow medium 6, such as air, and in the longitudinal direction of a rotational axis 8 an evap cooler 10 (evaporative cooler), an intake air heating device 12, a compressor inlet 14, a compressor 16, a compressor pre-guide blade adjusting device 18, an anti-icing device 20, a compressor outlet 22, a burner unit 24 and a turbine unit 26.

In the given exemplary embodiment the elements 10, 12, 18 and 20 are shown in two parts or designed rotationally symmetrically to the rotation axis 8, which of course does not necessarily have to be the case.

The gas turbine also has a drive shaft 28, which can rotate about the rotation axis 8 and extends longitudinally along the gas turbine 2. The drive shaft 28 connects the turbine unit 26 to the compressor 16 in a positive drive/rotational manner.

The compressor 14 has a sequence of axially arranged compressor guide blade stages 30 and compressor blade stages 32. At least one stage or row of compressor guide blades is prepared for adjustment, i.e. twisting against the main flow direction 4 of the flow medium 6, by the compressor pre-guide blade adjusting device 18.

During operation of the gas turbine 2, after flowing through the evaporative cooler 10 and the intake air heating device 12, the flow medium 6 flows through the compressor inlet 14 into the compressor 16. In the compressor 16 the flow medium 6 is compressed and thereby heated to 300° C. to 500° C. Via the compressor outlet 22, the compressed flow medium 6 is supplied to the burner unit 24, which can be designed in the form of a ring burner unit for example. The burner unit 24 has one or more combustion chambers 34 each with one burner 36.

The compressed flow medium 6 coming from the compressor 16 is at least portionally directed into the burner unit 24 or combustion chamber 34 and mixed there with a gaseous or liquid fuel. The ignitable mixture thus formed in the burner unit 24 is then ignited or burned and the combustion gas or working gas formed by combustion is taken via a transition channel 38 to the turbine unit 26 of the gas turbine 2.

The anti-icing device, which is arranged at the downstream end of the compressor 16 in structural proximity to the compressor outlet 22, is prepared for guiding part of the compressed, heated flow medium 6 to the compressor inlet 14.

Connected to the drive shaft 28, the turbine unit 26 has several turbine wheels 40 with turbine blades 42. In addition, guide blades 44 are arranged axially between the turbine wheels 40. The guide blades 44 of the turbine unit 26 are in turn connected to a stator 46.

The combustion gas from the combustion chamber(s) 34 enters the turbine unit 26 and drives the turbine blades 42 in such a way that the drive shaft 28 is driven rotationally and a torque is generated about the rotation axis 8 of the gas turbine 2. The purpose of the guide blades 44 is to direct the combustion gas or working gas to the turbine blades 42, i.e. flow guiding.

The compressor blade stages 32 are driven by the drive shaft 28, i.e. through the torque generated in the turbine unit 26, and are made to turn about the rotation axis 8, through which the compressed flow medium 6 is generated by the gas turbine 2 itself as soon as it is in an appropriate operating state.

The gas turbine 2 also has a control arrangement 48, which in order to be seen better is shown outside or structurally separated from the gas turbine 2 in FIG. 1. The control arrangement 48 has an actuating device 50, a determining device 52 and a control unit 54. Among other things, the control arrangement 48 is for controlling operation of the gas turbine 2 in part load operation.

The actuating device 50 is prepared for actuating the compressor pre-guide blade adjusting device 18 in order to initiate an adjustment of the compressor guide blade stages 30 against the main flow direction 4.

The determining device 52 is prepared for determining a compressor pre-guide blade adjustment limit value depending on the state of the flow medium 6, in particular on its temperature and humidity. The determining device 52 is also intended for comparing a value of the current compressor pre-guide blade adjustment ensuing in operation with the compressor pre-guide blade adjustment limit value.

The control unit 54 serves for controlling the evaporative cooler 10, the intake air heating device 12 and the anti-icing device 20 when the value of the initiated compressor pre-guide blade adjustment meets a predefined condition relating to the compressor pre-guide blade adjustment limit value.

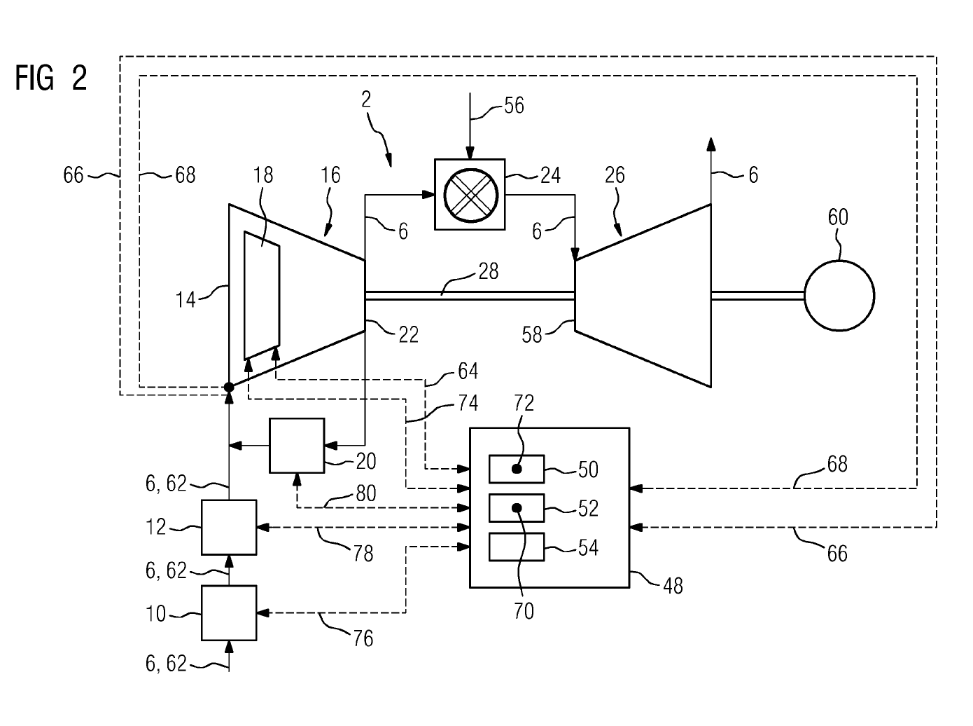

A schematic view of a control circuit for controlling the operation of the gas turbine system 2 in part load operation is shown in FIG. 2 and described below. When the gas turbine system 2 is in operation, after flowing through the evaporative cooler 10 and the intake air heating device 12, the flow medium 6 flows from an environment not described in more detail into the compressor inlet 14 of the compressor 16 of the gas turbine system 2. The flow medium 6 is compressed in the compressor 16, exits the compressor 16 via the compressor outlet 22 and then enters the burner unit 24.

In the burner unit 24, from the compressed flow medium 6 through the addition of a fuel mass flow 56, for example a mass flow of a gas, an ignitable mixture is produced and ignited, wherein, in particular, the ignition takes place continuously.

The ignited flow medium 6 leaves the burner unit 24 in the main flow direction 4 (see FIG. 1) and, via the turbine inlet 58, enters the turbine unit 26 of the gas turbine system 2 and starts to rotate the turbine wheels 40 (se FIG. 1) in such way that a torque is transferred to the drive shaft 28.

Part of an output of the gas turbine system 2 resulting from the thus generated torque and the speed of the drive shaft 28 is transmitted to the compressor 16 mounted on the drive shaft side in order to carry out compression work. Another part of the output of the gas turbine system 2 is transmitted as effective power to a generator 60 and converted into electrical energy therein.

On the basis of a nominal load operation of the gas turbine system 2, in order to operate the gas turbine system 2 in part load operation, for example at 80% of the nominal load, throttling takes place, e.g. the intake air mass flow 62 is reduced through an adjustment of the compressor pre-guide blades and/or one or more compressor guide blade stages 30 (see FIG. 1). To adjust the compressor guide blade stages 30, the compressor pre-guide blade adjusting device 18 is actuated with a control signal 64 emanating from the actuating device 50, which in the exemplary embodiment shown here is part of the control arrangement 48.

The control arrangement 49 records or determines a temperature value (the “temperature”) and a humidity or moisture content value (the “humidity”, “moisture content”) of the flow medium 6 flowing into the compressor inlet 14, i.e. an intake air temperature 66 and an intake air humidity 68. Determination of the intake air humidity 68 and the intake air temperature 66 can, for example, take place by way of suitable sensors or other measuring devices, wherein the sensors or the measuring devices can also be an integral part of the control arrangement 48.

As a function of the intake air temperature 66 and intake air humidity 68, the determining device 52 determines a compressor pre-guide blade adjustment limit value 70. The compressor pre-guide blade adjustment limit value 70 is, in particular, an adjustment limit value; when said adjustment limit value is attained or exceeded or fallen below, icing of the intake air mass flow 66 flowing into the compressor inlet 14 is to be expected. Normally the lower the intake air temperature 66 and the higher the intake air humidity 68 are, the greater the risk of icing.

The determining device 52 also compares the compressor pre-guide blade adjustment limit value 70 with the value of the initiated compressor pre-guide blade adjustment, the actual value 72 of the compressor pre-guide blade adjustment which is sent as a signal 74 to the actuating device 50 by the compressor pre-guide blade adjusting deice 18. However, this sending to the actuating device 50 is not imperative as the value 72 can also be stored and/or called up as an actuating value in the actuating device 50.

This comparison results in the following essential control or regulating states:

If the actual value 72 of the compressor pre-guide blade adjustment does not attain the compressor pre-guide blade adjustment limit value 70, i.e. the permissible range for adjustment is observed—if a further reduction in the part load is to be achieved—further throttling can take place, that is to say compressor pre-guide blade adjustment by way of the actuating device 50, the control signal 64 and the compressor pre-guide blade adjusting device 18.

If the actual value 72 of the compressor pre-guide blade adjustment attains or falls below the compressor pre-guide blade adjustment limit value 70, i.e. the permissible range for adjustment is not observed and icing in the compressor 16 can occur, the control unit 54 initiates at least one measure for changing the intake air temperature 66 or the intake air humidity 68:

One measure is actuating the evaporative cooler 10 via the control signal 76 in order to deactivate it. This measure assumes that at the time of actuation the evaporative cooler 10 is activated, i.e. operating in order to humidify or cool the intake air mass flow 62. In conventional gas turbine systems 2 this is usual in the case of nominal load operation. Through deactivating the evaporative cooler 10 an increase in the intake air temperature 66 and/or a reduction in the intake air humidity 68 is/are achieved. This in turn results in positive influencing of the compressor pre-guide blade adjustment limit value 70 since the risk of icing decreases as the intake air temperature 66 increases and the intake air humidity 68 falls.

A further measure is an actuation of the intake air heating device 12 by way of the control signal 78 in order to activate or control it. The activated or controlled intake air heating device 12 heats the intake air mass flow 62, i.e. increases the intake air temperature 66, which, in particular, can also result in a reduction in the intake air humidity 68. This, in turn leads to positive influencing of the compressor pre-guide blade adjustment limit value 70 as the risk of icing decreases with increasing intake air temperature 66 and falling intake air humidity 68.

A further measure is the actuation of the anti-icing device 20 by way of the control signal 80 in order to activate or control it. The activated or actuated anti-icing device 20 diverts off a hot air mass flow 82 at the compressor outlet 22 and supplies this to the intake air mass flow 62. Through the supply of the hot air mass flow 82 which is generally at a temperature of between 300° C. to 500° C. the intake air temperature 66 increases which, in particular, can also result in a reduction in the intake air humidity 68. This in turn leads to a positive influencing of the compressor pre-guide blade adjustment limit value 70 as the risk of icing decreases with increasing intake air temperature 66 and falling intake air humidity 68.

The described measures can be implemented individually or in combination, simultaneously or offset in time.

The described measures bring about a reduction in the risk of icing in the compressor 16, thus a reduction in the compressor pre-guide blade adjustment limit value 70, which usually relates an angle of attack of the compressor pre-guide blade with regard to the main direction of flow 4. As a consequence of this the actual value 72 of the compressor pre-guide blade adjustment can be reduced by actuating the compressor pre-guide blade adjusting device 18 via the signal 64 emanating from the control arrangement 48 without icing being anticipated. Through the now stronger throttling of the flow medium 6 in the compressor inlet 14 a reduction in the intake air mass flow 62 is achieved.

Through the thus achieved further reduction in the intake air mass flow 62, a partial load operation of the gas turbine system 2 is achieved, which is particularly more fuel efficient and lower in pollutant emissions, especially in the case of low ambient air temperatures and high ambient air humidities.

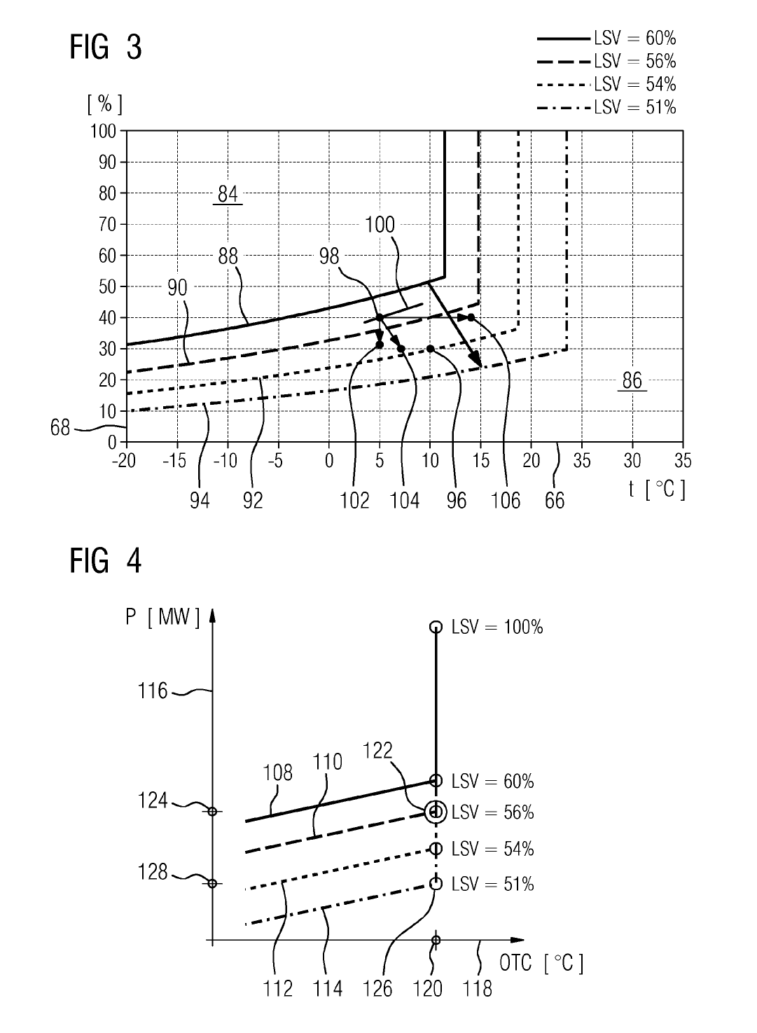

FIG. 3 shows a diagram with gas turbine system state ranges (84; 86) and limit curves (88, 90, 92, 94) of control engineering relevance as a function of the intake air humidity 68 (y-axis [%]) and the intake air temperature 66 (x-axis [° C.]) in accordance with the exemplary embodiment in FIG. 2. Using the diagram in FIG. 3 it can be clarified whether icing of the compressor inlet 14 (see FIG. 1, 2) can occur at a certain throttling level—i.e. at a certain compressor pre-guide blade adjustment—depending on the given combination of intake air humidity 68 and intake air temperature 66.

The limit curves 88, 90, 92 and 94 relate to a compressor pre-guide blade adjustment of 60%, 56%, 54% and 51%. In state range 84 which lies above the limit curves 88 and/or 90 and/or 92 and/or 94, icing of compressor inlet can occur. In state range 86 which lies below or to the right of the limit curves 88 and/or 90 and/or 92 and/or 94, no icing is possible.

For example, assuming a state 96 on the limit curve 92, i.e. at a compressor pre-guide blade adjustment of 54%, an inlet air temperature 66 of 10° C. and an inlet air humidity 68 of 30%, directly above or to the left of state 96 icing can occur, directly below or to the right of state 92 no icing can occur.

In part load operation of the gas turbine 2 (see FIG. 1, 2) with an intake air temperature 66 of 5° C. and an intake air humidity 68 of 40%, i.e. in state 98, and compressor pre-guide blade adjustment of 60% (limit curve 88) there is no risk of icing. The decisive compressor pre-guide blade adjustment limit value 70 in this state 98 is around 58% and is illustrated by the limit curve 100.

To reduce the output of the gas turbine 2 (see FIG. 1, 2) in part load operation in state 98, the intake air mass flow 62 is reduced by way of actuating a compressor pre-guide blade adjustment of 56%. The value of the compressor pre-guide blade adjustment of 56% is below the compressor pre-guide blade adjustment limit value 70 of around 58%/the limit curve 100 decisive in state 98, and icing of the compressor inlet 14 can therefore occur.

On the basis of state 98 at least one measure is initiated to change the intake air temperature 66 and/or the intake air humidity 68, for example through actuating the anti-icing device 20 and/or the intake aid heating device 12 and/or the evaporative cooler 10 (see FIG. 1, 2). As a result of this, through heating and drying of the intake air mass flow 62 a state 104 is achieved with an intake air temperature 66 of 7° C. and 30% intake air humidity 68. The state 104 lies below the limit curve 90 so that consequently no icing of the compressor inlet 14 can occur in this part load operation of the gas turbine system 2.

In the thus actuated state 104 a compressor pre-guide blade adjustment limit value 70 of around 55% results. This means that further throttling can be carried out, namely from 56% to 55% compressor pre-guide blade adjustment in order to achieve a part load operation of the gas turbine system 2 with a further reduced intake air mass flow 62 and accordingly reduced gas turbine output.

Alternatively any other state within the limit curve 90 can also be actuated, for example states 102 or 106.

FIG. 4 shows a diagram with gas turbine system performance curves (108-114) of control engineering relevance (gas turbine output 116 y-axis [MW]) as a function of the compressor pre-guide blade adjustment and an exhaust gas temperature 118 of the gas turbine system 2 (x-axis [° C.]) in accordance with the exemplary embodiment in FIG. 2. By way of the diagram in FIG. 4 it can be shown to what extent the actual value 72 of the compressor pre-guide blade adjustment (see FIG. 2, 3) influences the gas turbine output 116, particular at a constant exhaust gas temperature 118 in the part load range.

At an exhaust gas temperature value 120 and a compressor pre-guide blade adjustment value 122 of 56%, an output value 124 results. At the identical, i.e. constantly maintained exhaust gas temperature value 120 and a reduced compressor pre-guide blade adjustment value 126 of 51%, a reduced output value 128 comes about.

1. A method of operating a gas turbine system in part load operation, the method comprising:
with a given state of a flow medium flowing into a compressor of the gas turbine system, initiating a compressor pre-guide blade adjustment for part load operation,
comparing a value of the initiated compressor pre-guide blade adjustment with a compressor pre-guide blade adjustment limit value which is determined depending on the state of the flow medium flowing into the compressor of the gas turbine system, and
if the value of the initiated compressor pre-guide blade adjustment fulfils a predefined condition with regard to the compressor pre-guide blade adjustment limit value,
initiating at least one measure for changing the state of the flow medium flowing into the compressor of the gas turbine system in part load operation.

2. The method as claimed in claim 1,
wherein the given state of the flow medium flowing into the compressor of the gas turbine system is at least described by a temperature and/or humidity of the flow medium.

3. The method as claimed in claim 1,
wherein the compressor pre-guide blade adjustment limit value is determined depending on a temperature and/or a humidity of the flow medium flowing into the compressor of the gas turbine system.

4. The method as claimed in claim 1,
wherein the at least one measure brings about
an increase in a temperature and/or
a reduction in a humidity
of the flow medium flowing into the compressor of the gas turbine system in part load operation.

5. The method as claimed in claim 1,
wherein the at least one measure is initiated through
an activation
of an anti-icing device and/or
of an intake air heating device and/or
of a turbine exhaust gas return device and/or
of an intake air drying device and/or
a deactivation
of an evaporative cooler and/or
of a compression inlet air chiller and/or
of a water injection device.

6. The method as claimed in claim 1,
wherein the value of the initiated compressor pre-guide blade adjustment is an incremental value or an absolute value.

7. The method as claimed in claim 1,
wherein the value of the initiated compressor pre-guide blade adjustment is an angle.

8. The method as claimed in claim 1,
wherein the compressor pre-guide blade adjustment limit value is
an upper limit value and the predefined condition is attaining or exceeding the upper limit value or
a lower limit value and the predefined condition is attaining or falling below the lower limit value.

9. The method as claimed in claim 1,
wherein the method is carried out in each case for a plurality of successive points in time.

10. The method as claimed in claim 1,
further comprising controlling a temperature and/or a humidity of the flow medium flowing into the compressor of the gas turbine system in part load operation.

11. The method as claimed in claim 1,
further comprising controlling operation of a gas turbine system in part load operation, in which
one control variable is the temperature and/or
one control variable is the humidity,
one actuating variable is the value of the initiated compressor pre-guide blade adjustment and
one control signal actuates an anti-icing device and/or
one control signal actuates an intake air heating device and/or
one control signal actuates an evaporative cooler.

12. An arrangement for controlling a gas turbine system in part load operation, comprising:
an actuating device set up in such a way that
in a given state of a flow medium flowing into a compressor of the gas turbine system a compressor pre-guide blade adjustment is initiated and
a determining device set up in such a way that
a compressor pre-guide blade adjustment limit value is determined depending on the state of the flow medium flowing into the compressor of the gas turbine system and
a value of the initiable compressor pre-guide blade adjustment is compared with the compressor pre-guide blade adjustment limit value, and
a control unit set up in such a way that
at least one measure is initiated for changing the state of the flow medium flowing into the compressor of the gas turbine system in part load operation if the value of the initiated compressor pre-guide blade adjustment fulfils a predefined condition in relation to the compressor pre-guide blade adjustment limit value.

13. The arrangement as claimed in claim 12,
wherein the control unit is adapted for actuating an anti-icing device and/or an intake air heating device and/or an evaporative cooler.

14. A gas turbine system having
a compressor pre-guide blade adjusting device,
an anti-icing device and/or an intake air heating device and
an arrangement as claimed in claim 12.
